(19) United States
(12) Patent Application Publication
(10) Pub. No.: US 2025/0096641 A1
(43) Pub. Date: Mar. 20, 2025

(54) Dynamo Power AC Generator

(71) Applicant: Reginald Keith Sapp, Clinton, MD (US)

(72) Inventor: Reginald Keith Sapp, Clinton, MD (US)

(21) Appl. No.: 18/750,721

(22) Filed: Jun. 21, 2024

(51) Int. Cl. H02K 7/18; H02K 11/26

(52) U.S. Cl. CPC H02K 7/1815; H02K 11/26

(57) ABSTRACT

A DC alternator FIG. 1 becomes an AC generator from car parts with it reconfigured for its output. The engine FIG. 3 drives the DC alternator by gas and its purpose is for AC power.

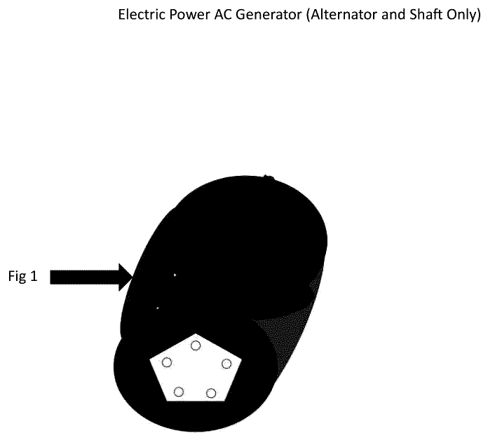

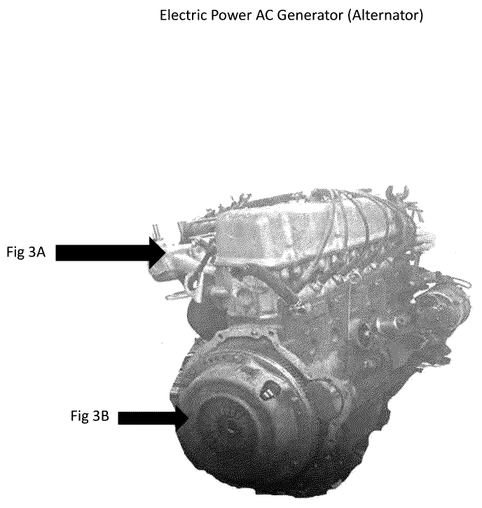

FIG. 3A is a 280ZX, 4 to 6 2753 cc inline Fuel Injection cylinder, 5,200 rpm, Horsepower 4 stroke car engine which is used to drive the attached Generator (Alternator) FIG. 1A and bolted housing FIG. 3B.

FIG. 1A The Generator (Alternator) model is an electrical copper coil winding in a metal housing that outputs an AC current by the rotation on the engine FIG. 3A 4 to 6 inline Fuel Injection cylinder, 2753 cc, 5,200 rpm Horsepower 4 stroke engine.

The gas can be unleaded or diesel.

FIG. 1 the Generator (Alternator) metal housing is bolted to the metal housing of the engine housing FIG. 3B and the engine 3A

1. We found that the Configuration and Body FIG. 1 is from a 4 stroke or 6 stroke straight block engine FIG. 3 and reconfiguring its structure to output a high voltage, amp and power. This allows for electrical power to be outputted at a high volt and high amp.
We set gauges up to measure the output current of the alternator which is able to power private homes, constructions, and community buildings, stadiums and more.
We found that the AC Generator FIG. 1 configuration is a stronger Alternator (Generator) with output from used parts.
